(19) United States
(12) Patent Application Publication
(10) Pub. No.: US 2025/0091947 A1
(43) Pub. Date: Mar. 20, 2025

(54) Encapsulation of Biological Materials for Concrete and/or Mortar Structural Healing

(71) Applicant: Lawrence Livermore National Security, LLC, Livermore, CA (US)

(72) Inventors: Nancy Merino, Dublin, CA (US); Amy Wat, Oakland, CA (US); Jiaqi Li, Hayward, CA (US)

(21) Appl. No.: 18/882,558

(22) Filed: Sep. 11, 2024

Related U.S. Application Data
(60) Provisional application No. 63/539,303, filed on Sep. 19, 2023.

(51) Int. Cl. C04B 20/10; C04B 24/38; C04B 103/00; C04B 111/72; E04G 23/02

(52) U.S. Cl. CPC C04B 20/10; C04B 24/383; E04G 23/0203; C04B 2103/0001; C04B 2111/72

(57) ABSTRACT

A vascularizing, crack sealing and/or corrosion reducing repair formulation for concrete, and corresponding methods. In one general embodiment, a repair formulation includes a casting material, and an encapsulated and/or non-encapsulated biological material in the casting material. The biological material is operative to enable concrete and/or mortar structural healing. A method for non-destructive evaluation of cementitious material, in accordance with one general embodiment, includes causing a repair formulation to vascularize along a crack in the cementitious material via a biological and/or non-biological effect, characterizing the vascularized repair formulation, and outputting a result derived from the characterization.

### RELATED APPLICATIONS

This application claims priority to U.S. Provisional Appl. No. 63/539,303 filed on Sep. 19, 2023, which is herein incorporated by reference.

This invention was made with Government support under Contract No. DE-AC52-07NA27344 awarded by the United States Department of Energy. The Government has certain rights in the invention.

### FIELD OF THE INVENTION

The present invention relates to concrete repair, and more particularly, this invention relates to a repair formulation having encapsulated biological materials to enable concrete structural healing.

### BACKGROUND

Current concrete repair technology requires either replacement of aged concrete—which is tedious, expensive, and logistically onerous—or one-time sealing of defects (e.g., grout injection or healing spray) that do not provide prolonged crack repair.

Modern corrosion prevention methods have issues stemming from corrosion inhibitors that require concrete cover replacement and contain toxic solvents. Previous attempts at bio-inspired approaches cannot repair both existing and newly formed deep defects in both reinforced and plain concrete with prolonged functions.

The need for an innovative concreate repair solution is particularly great for decades-old marine concrete structures that are instrumental for multi-billion-dollar government complexes, and in scenarios where munitions damage to airfield pavements could lead to logistical delays for warfighters.

What is needed is an innovative solution that provides better results than conventional concrete and mortar repair schemes.

### SUMMARY

In one general embodiment, a repair formulation includes a casting material, and an encapsulated and/or non-encapsulated biological material in the casting material. The biological material is operative to enable concrete and/or mortar structural healing.

A method for non-destructive evaluation of cementitious material, in accordance with one general embodiment, includes causing a repair formulation to vascularize along a crack in the cementitious material via a biological and/or non-biological effect, characterizing the vascularized repair formulation, and outputting a result derived from the characterization.

Other aspects and advantages of the present invention will become apparent from the following detailed description, which, when taken in conjunction with the drawings, illustrate by way of example the principles of the invention.

### BRIEF DESCRIPTION OF THE DRAWINGS

FIG. 1A is a schematic diagram of a repair formulation, as well as use of the repair formulation, in accordance with various aspects of the present invention.

FIG. 1B is a schematic diagram of the repair formulation of FIG. 1A after solidification thereof and a load being applied to the concrete.

FIG. 1C depicts exemplary capsules, in accordance with one aspect of the present invention.

FIG. 1D depicts exemplary capsules, in accordance with one aspect of the present invention.

FIG. 2A is a schematic diagram of vascularization of a repair formulation using magneto-rheology, in accordance with one aspect of the present invention.

FIG. 2B is a schematic diagram of vascularization of a repair formulation by fungal vascularization, in accordance with one aspect of the present invention.

FIG. 3A is a schematic diagram of a capsule with an enzyme, in accordance with one aspect of the present invention.

FIG. 3B is a schematic diagram of a capsule with a microbe, in accordance with one aspect of the present invention.

FIG. 4 is a schematic diagram of a chlorine binding capsule, in accordance with one aspect of the present invention.

FIG. 5 is a flow diagram of a method for non-destructive evaluation of cementitious material, in accordance with one general embodiment.

FIG. 6 is a flow diagram of a method for forming capsules, in accordance with one embodiment.

FIG. 7 is a graphical representation of a mortar beam subjected to three-point bending, in accordance with one exemplary approach.

FIG. 8 is a system diagram of a loading system for creating stress on a beam, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm, a temperature of about 50° C. refers to a temperature of 50° C.±5° C., etc.

A “nano” dimension or descriptor such as nanoscale, nanoporous, etc. is defined as having a diameter or length (e.g., a pore having an average diameter) less than 1000 nanometers (nm). A “micro” dimension or descriptor such as microscale, microporous, micron-sized, etc. is defined as having a diameter or length (e.g., a pore having an average diameter) less than about 1000 microns (μm).

It is also noted that, as used in the specification and the appended claims, wt. % is defined as the percentage of weight of a particular component relative to the total weight/mass of the mixture. Vol. % is defined as the percentage of volume of a particular compound relative to the total volume of the mixture or compound. Mol. % is defined as the percentage of moles of a particular component relative to the total moles of the mixture or compound. Atomic % (at. %) is defined as a percentage of one type of atom relative to the total number of atoms of a compound.

Unless expressly defined otherwise herein, each component listed in a particular approach may be present in an effective amount. An effective amount of a component means that enough of the component is present to result in a discernable change in a target characteristic of the ink, printed structure, and/or final product in which the component is present, and preferably results in a change of the characteristic to within a desired range. One skilled in the art, now armed with the teachings herein, would be able to readily determine an effective amount of a particular component without having to resort to undue experimentation.

The following description discloses several preferred embodiments of a preferably ready-to-use, vascularizing, crack sealing and/or corrosion reducing repair formulation and corresponding methods. The repair formulation, in various approaches, includes encapsulated and/or unencapsulated biological materials to enable concrete and/or mortar structural healing. In some approaches, the repair formulation includes a tunable and long-lasting system composed of a casting suspension, such as a gelcasting suspension, which incorporates concrete strengthening materials (e.g., a polymeric network, a polymer gel network, lignocellulosic substrates, etc.), magnetic particles in some aspects, and capsules containing biological materials. The repair formulation in some approaches is designed to penetrate deep within concrete via magnetic particles (e.g., for magneto-rheological (MR) methods) and/or bioengineered filamentous fungi. The capsules are preferably composed of bio-compatible shells, enabling long-term durability for encapsulated materials (enzymes and/or fungi) that provide vascularization, self-healing, and/or corrosion prevention upon capsule rupture by an applied stimulus (e.g., increased pressure, crack opening, pH changes, vehicle or aircraft passes thereover, environmental stimuli changes (e.g., temperature changes, vibration, electromagnetic forces, crack propagation, etc.), etc.). The product, in preferred approaches, may be designed to be malleable for the conditions and needs of the damaged concrete structures but derives its capabilities from various key biological and non-biological mechanisms, alongside features within the casting suspension.

Various aspects of the present invention described herein provide one or more of the following advantages: (1) long-term function for vascularizing effectors, (2) a novel delivery mechanism for deep vascularization, (3) minimal upkeep or renewal required, (4) versatile solution for both steel-reinforced and non-reinforced concrete, and (5) novel portable non-destructive evaluation (NDE) to monitor performance.

Various repair formulations described herein may be tuned according to the application space and the diagnostic needs to deliver an effective solution for prolonged crack repair in aged concrete structures.

As will be described in more detail below, various aspects of the present invention provide solutions to revolutionize concrete crack repair via a tunable, long-lasting formulation that is compatible with the cementitious environment, and that combines prolonged self-healing and vascularizing functionality; deep (>½ meter (m)) integration of self-healing vasculature imparted by magneto-rheological fluids and/or bioengineered filamentous fungi; crack healing and/or self-repair provided by timed-release capsules containing biomaterials for CaCO₃ biomineralization (e.g., microbial and/or enzymatic) and/or corrosion prevention (e.g., via Cl⁻ binding (e.g., enzymatic and/or calcite layered double hydroxides); application of NDE diagnostics with simulations and machine learning that provide predictions for structural serviceability; and/or a ready-to-use repair formulation application, preferably packaged, for restoration of aged concrete such as marine concrete, terrestrial concrete, and/or damaged airfield pavements.

Some approaches may provide a drop-in solution for prolonged (e.g., at least one year, at least two years, at least five years, and in some cases one or more decades) function for vascularization crack healing and/or corrosion prevention to up to and beyond ½ m depth in concrete, with minimal upkeep or renewal, while providing renewed concrete strength, e.g., strength comparable to (e.g., at least about 80% of the strength of) the undamaged concrete adjacent the crack; to some predefined level, e.g., at least 20 MPa, at least 35 MPa, etc.; etc. Other approaches may provide repairs having lower compressive strength values.

In general, a repair formulation includes a casting material and an encapsulated and/or non-encapsulated biological material in the casting material. The biological material is operative to enable concrete and/or mortar structural healing.

Preferred embodiments use a casting suspension as the casting material, ideally a gelcasting suspension, to which biological materials are added, e.g., in encapsulated form and/or mixed therewith.

Other aspects use grout, mortar, or a dry powder blend (e.g., wood powder, wood chips, coffee grounds, oat, chia seeds, flax seeds, millet flour, etc.) as the casting material to which biological materials are added, e.g., in encapsulated form and/or mixed therewith.

For simplicity, and to place various embodiments in a context to aid the reader, much of the following description refers to use of a casting suspension in concrete repair formulations. This has been done by example only, and is not to be deemed limiting in any way. Rather, any approach described herein that uses a casting suspension may instead use a grout, mortar, or a dry powder blend. Accordingly, any formulation described herein may use any of the casting materials listed herein interchangeably, in most cases in the same vol % relative to the total volume of the repair formulation. Similarly, any approach described herein as useful for repairing concrete may be used to repair any cementitious material such as concrete, mortar, plaster, etc.

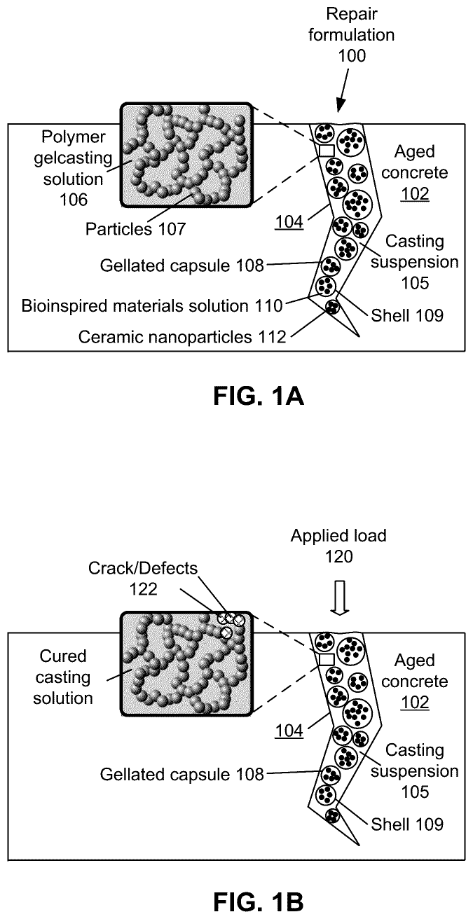

FIG. 1A illustrates, by way of example, a repair formulation 100, as well as use of the repair formulation 100, in accordance with various aspects of the present invention. As shown, the aged concrete 102 has a crack 104. The repair formulation 100, which in this example includes a casting suspension 105 comprised of a casting solution 106 and gellated capsules 108 (e.g., encapsulating biomaterials and/or other components required for function), has been injected into the crack 104.

The casting suspension 105 may be any material capable of being used in the manners described herein, whether in liquid or dry form.

The casting suspension 105 is preferably a gelcasting suspension that includes a fluid gelcasting solution 106 that can solidify into a gel. Examples of illustrative polymers for the gelcasting suspension include agar, agarose, polyvinyl alcohol (PVA), hydrogels, guar gum, acacia gum, xanthan gum, phytagel, and the like.

Because a gelcasting suspension is a preferred embodiment, much of the present description refers to a gelcasting suspension. This has been done by way of example only, and any other type of casting suspension described herein may be used in place of the gelcasting suspension in the various approaches described herein.

Other examples of materials that may be incorporated into the casting suspension 105 include calcium phosphate, methylcellulose, diatomaceous earth (as known as diatomite), cement, calcined-layered double hydroxide, iron oxides, Darvan 811. The casting suspension formulation may be foamed up with a surfactant (e.g., F127, Pluronic 7 or the like).

One or more curing agents may be present in the casting suspension 105 in an effective amount (e.g., up to about 20%) for providing at least a predefined amount of curing of the casting solution 106 of the casting suspension 105. In one approach, citric acid is present to initiate hardening. In another approach, an agarose suspension is mixed with the foaming agent. The casting suspension may then cure and/or be cured according to the relevant characteristics of the casting suspension, such as the polymer used, curing agent(s) used, etc.

One or more types of particles 107 may be added to the casting suspension 105 for various purposes. Such particles may include ceramic particles, cement and/or mineral particles. For example, one or more types of mineral particles may be added to the casting suspension to make the gel more stiff, e.g., to impart green body strength right after curing of the casting suspension. Examples of mineral particles include silica, aluminum oxide, diatomaceous earth, zirconia, calcium carbonate, iron oxide, carbonated iron particles, other types of metal oxides, and/or any other type of mineral that would become apparent to one skilled in the art after reading the present disclosure. The mineral particles may be present in the casting suspension or the repair formulation in a range of about 5 vol % to about 50 vol % or higher relative to the total volume of the casting suspension or the repair formulation.

Other additives may be present in the casting suspension, such as plasticizers, calcium formate, calcium acetate, calcium nitrate, and calcium chloride, etc. in an effective amount of the respective additive to provide a desired effect, e.g., the purpose of adding the additive.

In some aspects, biological materials such as any of those presented herein may be present in the casting suspension 105, separately and/or instead of in the encapsulated particles. A general concentration of the biological materials in the casting suspension may be in a range of less than 25 vol % of the casting suspension.

In preferred approaches, the capsules 108 have shells 109 encapsulating biological materials such as fungi, yeast, enzymes, bacteria, in some cases in a solution 110.

Any suitable shell material may be used, with a polymeric shell being preferred. Preferably, the shell is something that is not going to damage the or kill the biological material inside.

Examples of shell materials include alginate, photosensitive polymers of known type, agar, agarose, cross linking by glutaraldehyde, transglutaminase, etc.

The capsules 108 may be present in the casting suspension 105 or the repair formulation 100 in a range of about 5 vol % to about 50 vol % or higher relative to the total volume of the casting suspension 105 or the repair formulation 100.

Any suitable technique for fabricating the capsules 108 that would become apparent to one skilled in the art after reading the present disclosure may be used. Examples include a complex coacervation technique in which solutions are mixed together and then electrostatic interactions are used to form the capsules themselves, and then the polymer shell is caused to cross-link, e.g., by adding in a cross linking agent such as gluteraldehydes or the like. Various aspects use an oil-water solution because they are immiscible. A surfactant may be used, such as Tween 80, Tween 40, Tween 60 and/or Tween 20. Note that the oil phase or the water phase may end up within the capsule, depending on the technique used.

Another method for fabricating the capsules 108 may include is a water-water encapsulation that uses the electrostatic characteristics of what is trying to be encapsulated. For example, E. coli is a gram-negative bacteria. The electrostatic environment is altered by slowly acidifying the water, e.g., by adding a little bit of acid at a time. What this does is encourage the E. coli and gelatin, agar, and/or agarose to form into small balls that can be cross linked. The change in the electrostatic environment causes them to form clusters.

Additional methods for fabricating the capsules may include known techniques that employ microfluidic bulk emulsification, in-air drop encapsulation, etc.

Nutrients for the biological materials may be provided in the capsules as well to promote long-term viability, preferably on the order of years. The particular types of nutrient(s) selected may be of a type that provides nourishment and/or stability to the particular biological material(s) used in the repair formulation. Exemplary nutrients, and concentrations of nutrients, are provided below.

The capsules 108 in some approaches also include ceramic nanoparticles 112 to impart properties to enable it to wick deep into the crack and/or to sustain and nourish those biological solutions.

In further approaches, the capsules 108 are configured as time release capsules, analogous to time-release drug delivery systems but preferably configured for much slower release. Known capsule shell materials that provide about a desired rate of release under the expected conditions of use may be used.

In yet other approaches, the capsules 108 are configured as chemical release capsules. For example, the shells 109 of the capsules may be of a known material that is characterized such that contact with a particular chemical may cause the capsule to rupture. In another example, a capsule may disintegrate over time, e.g., the shell of the capsule may be formed of a known material that deteriorates under the expected conditions of use at some approximated rate.

FIG. 1C depicts exemplary capsules, in accordance with one approach.

FIG. 1D depicts exemplary capsules, in accordance with one approach.

One or more nutrients may be added to the casting suspension 105, e.g., to the gelcasting solution 106, to provide nutrition to the biological materials in the capsules 108 upon release of the biological materials from the capsules. Any type of nutrient that would become apparent to one skilled in the art after reading the present disclosure may be used. In one approach, the nutrient is lignocellulosic materials. Other examples include lignin, cellulose, urea, maltose, yeast extract, peptone, glucose, nutrient broth, luria broth, M9 media, various calcium sources (e.g., calcium chloride, calcium phosphate, calcium lactate, calcium carbonate), various metal sources (e.g., nickel chloride), various salts (e.g., potassium chloride, magnesium sulfate, manganese sulfate, ammonium sulfate, ammonium chloride, magnesium chloride, sodium sulfate), various types of buffer (e.g., sodium citrate, sodium phosphate, bicine, sodium carbonate, CAPS, HEPES, PIPES, Tris buffer, monopotassium phosphate, dipotassium phosphate, sodium bicarbonate), etc. Additional examples include YNB and CSM, sold by Sunrise Science Products Company having a sales office at 127 Perimeter Park Rd., Suite A, Knoxville, TN 37922 U.S.A. Additional examples include inducing agents (e.g., IPTG) and antibiotics (e.g., kanamycin) for growing genetically engineered microorganisms and inducing gene expression.

Single nutrients may be used in some approaches. Combinations of nutrients may be used in any desired ratio. The nutrients may be present in the capsules 108 and/or in the casting solution 106 in a concentration of about 0.0001 grams per liter (g/l) to about 500 g/l. The concentration may be selected based on parameters such as the objective of the repair formulation, the types of biological materials, the target environment of use (e.g., cold, hot, seawater, etc.) etc.

Note that one or more nutrients be added to both the casting solution 106 and the capsules 108 having the biological materials. In such cases, the nutrients may be the same in both the casting solution 106 and the capsules 108; the nutrients in the casting solution 106 may be different than in the capsules 108; or some of the nutrients in the casting solution 106 are the same as nutrients in the capsules 108, while other nutrients are different.

In some approaches, the repair formulation may include second capsules having nutrients therein but no biological materials. This may be done for purposes of ensuring long term viability of the nutrients.

Upon hardening of the casting suspension, the resulting polymer network imparts rigidity in the crack. For example, the rigidity may be imparted by solidification behaviors of the minerals/cement being used.

Referring to FIG. 1B, after the repair formulation 100 is solidified in the crack 104 (e.g., the casting solution is cured), upon a load 120 being applied to the concrete 102, some of the shells 109 of the capsules 108 rupture and/or pop, thereby releasing their contents. As the shells rupture and/or pop, any defect 122, e.g., due to a crack, crushing, etc., that has been formed by the applied load 120 is filled by the contents of the capsules, which will then grow and form cementitious materials that can fill in the defect 122.

The inventors have overcome three primary challenges while developing the novel repair formulations described herein: (1) adapting novel vascularization approaches to heal deep defects, (2) designing the casting suspension and scaling-up the encapsulation process while maintaining bio-compatibility and efficient capsule cargo release under applied loads and/or environmental changes, and (3) optimizing the capsule cargo for encapsulation and prolonged (>4 months) self-healing vascularization and chloride binding functionalities.

Vascularizing Effectors for Prolonged Function and Deep Integration (≥½ Meter) within Concrete

Crack repair deep within concrete represents a grand challenge because of the need to transport substances for crack healing and prevention throughout the concrete structure. Current crack repair approaches do not integrate deep within concrete and are primarily a one-time, surface-level application and intervention without prolonged repair for new cracks (e.g., bio-based spray). Other extant approaches are expensive and time-consuming (e.g., replacing existing concrete), or only seal internal cracks of steel-reinforced concrete (e.g., via electrochemical deposition). The repair may also discontinue early with poorly restored strengths. Moreover, none of the existing approaches can repair both existing and newly-formed deep defects in both reinforced and plain concrete with prolonged functions. Nor can existing approaches provide the aforementioned defect repair, along with Cl⁻ binding capability for corrosion prevention. As such, it is of critical importance to develop methods that can integrate deep within concrete, providing a self-healing “vascular network.”

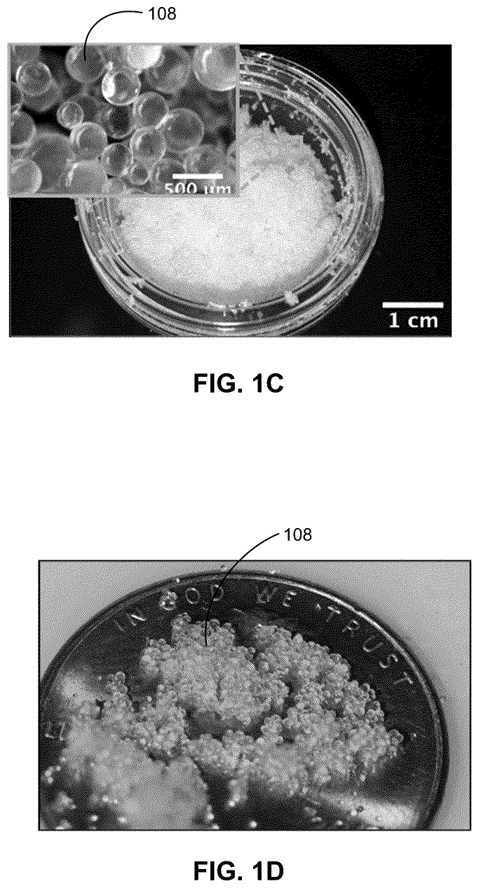

To address this need, various aspects revolve around two primary approaches for vascularization, as shown in FIGS. 2A and 2B, which depict an exemplary non-biological and an exemplary biological approach, respectively.

A non-biological approach, in accordance with one aspect of the present invention as shown in FIG. 2A, utilizes MR fluids by incorporating magnetic particles 202 within the gelcast suspension 204, enabling the application of a magnetic field 206 to urge the components in the suspension through sub-surface defects in concrete 208. Moreover, the magnetic particles 202 allow for higher sensitivity for NDE to detect self-healed cracks by increasing the spatial resolution for deeper and smaller cracks.

The biological approach, in accordance with one aspect of the present invention as shown in FIG. 2B, utilizes bioengineered filamentous fungi 220 that are compatible with bioengineered bacteria 222 and function within the cementitious environment 208, with enhanced function for vascularization and crack repair (e.g., microbial-induced CaCO₃ biomineralization, or MICP). For long term function, fungal spores may be encapsulated, which have a shelf-life spanning years (e.g., greater than 1 year, preferably greater than 10 years) and are able to be germinated by mixing with lignocellulosic substrates. Lignocellulosic substrates may be provided in the gelcast suspension to provide both increased concrete durability and nutrients for fungal growth upon capsule rupture.

### Encapsulation of Biological Materials for Prolonged Function to Repair Cracks and Bind Cl in Cementitious Environments

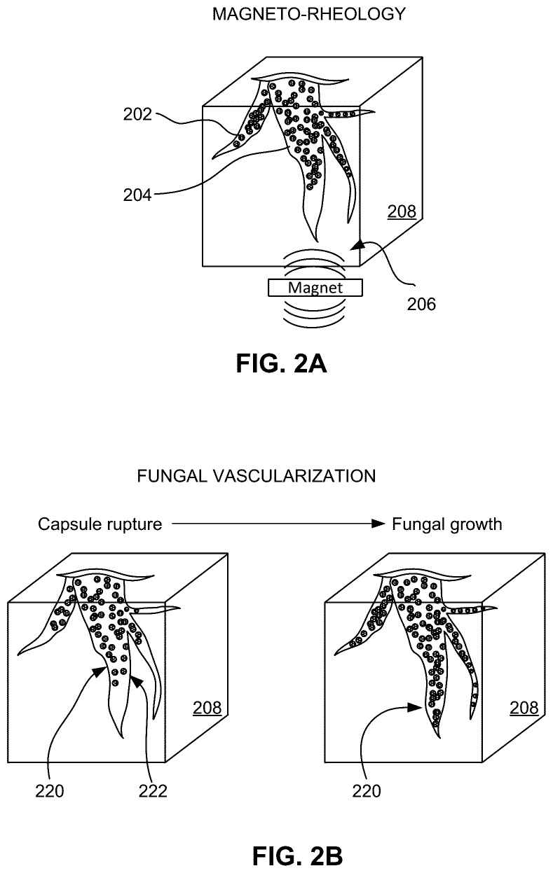

Prolonged (e.g., months to years) crack repair and functionality deep within concrete structures may require the persistence of materials in a highly alkaline environment, in some applications. Some crack healing techniques have attempted to use CaCO₃ precipitation via enzymatic or microbial processes; however, these processes may not function long-term or survive under cementitious conditions. However, the present solution overcomes this problem by the use of encapsulation for delayed-release of biological materials such as bioengineered fungi, yeast, bacteria, carbonic anhydrase (CA) enzyme, urease enzyme, and/or chlorinating enzyme. See FIGS. 3A and 3B, which depict CaCO₃ precipitation capsules and two alternate capsule cargo options for biomineralization, in accordance with various embodiments. Particularly, FIG. 3A depicts an enzyme 302 and corresponding chemical effect. A capsule 304 for such enzymes is also depicted. One or more additives 306 of a type mentioned elsewhere herein may also be present in the capsule 304. FIG. 3B depicts a microbe 320 (e.g., fungal spore) and corresponding chemical effect. A capsule 322 having the microbe 320 is also depicted. Additives 324 such as nutrients for the microbe 320 and/or of another type may also be present in the capsule 322. Other portions of FIGS. 3A and 3B are self-descriptive.

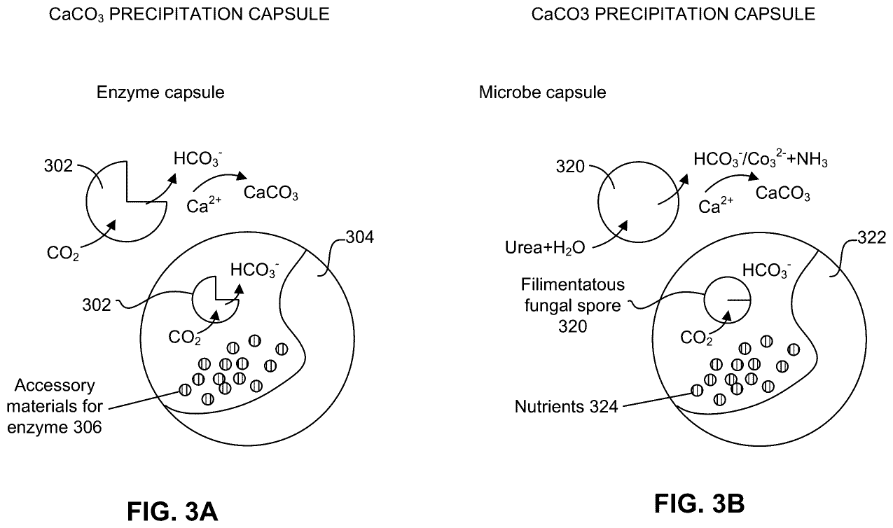

As mentioned above, the fungi used in various approaches may be engineered for both enhanced vascularization and microbial-induced calcite precipitation (MICP). Referring to the exemplary embodiment of FIG. 4, chlorinating enzymes 402 may also be encapsulated in a capsule 404 to catalyze the binding of chloride to various functional chemical groups (see, e.g., FIG. 4) and prevent corrosion in reinforced concrete structures. Accessory materials 406, e.g., stabilizers, etc., for the enzymes may also be present.

Encapsulating one or more of these biological materials enables long-term crack repair for both tracks and enables the enzymes, fungi, and/or bacteria to survive in a cementitious environment. CA provides a promising and economically viable CaCO₃ precipitation approach, and is readily biodegradable, odorless, and considered a safe catalyst. See, e.g., FIG. 3A.

Fungi may be engineered, via techniques known in the art, to be used for MICP by expressing the urea amidolyase enzyme, urease enzyme, and/or carbonic anhydrase enzyme. These enzymes have been demonstrated to form CaCO₃. For example, urea amidolyase enzyme can precipitate CaPO₄ (hydroxyapatite) in genetically engineered yeast Saccharomyces boulardii (a eukaryotic system). A protein engineering approach via directed evolution of a type known in the art may also be used to develop chlorinating enzymes for function under cementitious conditions, and to develop carbonic anhydrase for increased activity and activity under a range of environmental conditions (e.g., pH, temperature, salinity). The present general encapsulation and bioengineering approach delivers a novel system for prolonged self-healing crack repair and corrosion prevention under extreme cementitious conditions.

### Multi-Modal NDE Technologies to Evaluate Vascularization, Self-Healing, and Cl⁻ Concentrations

Current quality control methodologies for detection of cracks, vascularization, and corrosion do not have the resolution or ability to assess concrete. For example, ground-penetrating radar is the current state-of-the-art, but it has low resolution for heterogeneous materials like concrete. Electrical resistivity tomography can be used to detect Cl⁻ in concrete by mapping ingress-induced resistivity changes, but the sensitivity is limited by the heterogeneity of concrete, and can only be used on small concrete specimens.

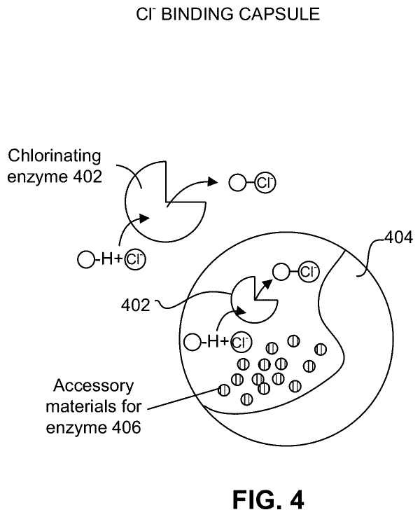

FIG. 5 shows a method 500 for non-destructive evaluation of cementitious material, in accordance with one general embodiment. As an option, the present method 500 may be implemented with repair formulations such as those described elsewhere herein and/or shown in the other Figs. described herein. Of course, however, this method 500 and others presented herein may be used to evaluate cementitious materials which may or may not be related to the illustrative embodiments listed herein. Further, the methods presented herein may be carried out in any desired environment. Moreover, more or less operations than those shown in FIG. 5 may be included in method 500, according to various embodiments. It should also be noted that any of the aforementioned features may be used in any of the embodiments described in accordance with the various methods.

In operation 502, a repair formulation is caused to vascularize along a crack in the cementitious material via a biological and/or non-biological effect, e.g., according to any approach described herein. See, e.g., use of fungi and/or MR techniques described elsewhere herein.

In operation 504, the vascularized repair formulation is characterized. The characterization can be any data that is obtained via any of the techniques for evaluation as described herein, e.g., as described below.

A result derived from the characterization is output in operation 506 in any usable form, e.g., in any form that would become apparent to one skilled in the art after reading the present disclosure. For example, the result may be derived from an artificial intelligence model trained to assess the data obtained during operation 504. The result may include any result described herein, e.g., see below.

As noted above, various aspects of each operation are found in the following description, including the next several sections.

Various aspects of the present invention include standalone and multi-model NDEs that can be complementary to each other, and in some aspects fused by artificial intelligence, toward desired performance and/or service condition evaluation of existing concrete structures. Various approaches include multi-modal NDE technologies (e.g., acoustic, microwave, and electric resistance) that may be deployed to bridge missing measurement gaps for monitoring the evolution of concrete vascularization, crack repair, and corrosion prevention. These aspects provide a brand-new research strategy for detecting signals from deep within the concrete. The multi-modal NDE aspect also advances the state-of-the art of NDE probes with high-density sensor element arrays that provide the unprecedented granularity of physical and chemical parameters across a large space.

### Predictive Modeling Enabled by NDE and Novel Testbeds

Sophisticated constitutive models exist to describe the elastic property, strength, and damage evolution in concrete. While it can be challenging to define a model to precisely predict concrete performance over the full range of loading cases and rates, it is generally possible to parameterize a model with sufficient accuracy to represent a specific concrete material in a given application space. However, predicting the concrete performance based on composition, microstructure, curing properties, aging and environmental effects, damage, and reinforcement type is a grand challenge that may require application of advanced methods for direct numerical simulation of material response at the microscale. In addition, application of multi-scale methods is needed to predict how the microscale mechanisms affect macroscale material response. The presence of significant organics within fractures, along with the chemical changes during healing, may significantly impact the elastic response across fractures, along with the strength and the fracture energy release rate during damage evolution, requiring application of novel computational approaches.

In various aspects, the evolution of the repair formulation in a crack may be modeled across multiple length scales. A variety of known methods can be used to upscale the response of a single fracture to a mesoscale model of a fracture network, but constitutive model forms prepared according to the teachings herein are preferably used to represent the response of a network of healed/filled fractures with local viscous, plastic, and damage effects to enable a continuum level study using component and structure modeling. Specification of spatially varying continuum properties based on NDE observables at the structural scale may use machine learning models trained in a conventional manner using data from testbed experiments and direct numerical simulation. These models may be used to characterize prolonged use of the repair formulation, e.g., by studying the effects of wet-dry cycles of seawater attack in accelerated aging testing to observe changes in mechanical properties of the healed concrete and ingress of chloride leading to corrosion. This wide toolbox of models, testing, and application significantly expands the state of the art by creating data for these biological-concrete composites at various length-scales.

Table 1 provides a comparison of the present (proposed) approach with state-of-the-art techniques, and the benefits provided by the proposed solution.

TABLE 1

| | State-of- | Proposed | |
|---|---|---|---|
| Area | the-Art | Solution | Benefits |
| Crack | Surface coating | Vascularization | Material can be forced |
| filling | | suspension | into deep cracks via |
| | | | magnetism or fungal |
| | | | growth; enables quality |
| | | | control (QC) |
| Crack repair | Self-healing | Encapsulated | Delayed-release of |
| | cement | biological | healing materials that |
| | | materials | can be introduced into |
| | | | cracks |
| QC | Radar | Integrated | Data at many length |
| diagnostics | | multi-modal | scales to study |
| | | NDE (portable, | corrosion, defects, and |
| | | in-situ) | crack healing |
| Predictive | Constitutive | Predictive | Model accounts for |
| modeling | models | modeling | aging, healing, and |
| | | | composition at multiple |
| | | | length scales |

As noted above, non-biological and biological vascularization methods may be used in various embodiments, though others that would become apparent to one skilled in the art after reading the present disclosure may also be used. Preferably, vascularization with prolonged function and ongoing crack healing and prevention is achieved. Described below, by way of example only, are vascularization methods using magneto-rheological fluids and fungal vascularization.

### Magneto-Rheology (MR)

A non-biological approach to urging a repair formulation deep into cracks, in accordance with various embodiments, uses MR fluids. The casting suspension includes magnetic particles, and with or without capsules (e.g., encapsulating biological components), is injected into a concrete structure from a surface crack. The components of the repair formulation may be forced through cracks by strategically manipulating magnetic fields at the surface to direct the components through most, and ideally all, connected cracks within the concrete structure. This “flow-on-demand” may be obtained with either the use of permanent magnets or electromagnets (EM). The strength and direction of the magnetic field is preferably selected to prevent the release of the repair formulation into adjacent environments.

Rheological studies may be conducted with an EM-equipped rheometer to select a solids loading, particle size, and magnetic particle composition appropriate for a desired application. The magnetic particles should be compatible with a casting suspension for MR. Magnetic particle size and composition affect particle dispersion, dielectric properties, and magnetic permeability. A preferred average size (diameter) of the magnetic particle is in the micrometer range (<100 micrometers), and in some approaches in the nanometer range (<1000 nm). The magnetic particles may have a very narrow size distribution, or may have a variety of sizes within a selected range. The magnetic particles may be formed of any magnetic material and/or alloy thereof. Illustrative magnetic particles comprise FeO and/or Fe.

The magnetic particles impart dielectric properties with a higher contrast, which enables higher sensitivity for quality control (QC) diagnostics and verification, preferably via NDE.

### Fungal Vascularization

Various fungal strains are suitable for concrete repair, with those having the ability to vascularize within concrete cracks under marine conditions and/or with a relatively higher capacity to repair cracks (than other strains) being preferred. Illustrative species/strains that may be used in various approaches include, but are not limited to: Pleurotus ostereatus, Trichoderma reesei, Pleurotus eryngii, Ganoderma lucidum, Ganoderma multipileum, Trametes versicolor, Letinus edodes, Pholiota adiposa, Stropharia rugosoannulate, Hericium erinaceus, and/or Clitocybe nuda that are capable of vascularization, etc. These species are easy to cultivate, tolerate a range of environmental conditions, and/or form tough materials. Different strains in the same species are known to show different properties. For example, a variant of P. ostereatus can grow up to 50% in 3% NaCl condition compared to salt-free media.

Note that the fungus may perform one or more functions, including the aforementioned vascularization, concrete healing, formation of a scaffold for other biological materials to perform their function, etc.

Note further that bacteria that are symbiotic with fungi may be present in the capsule. The bacteria may be genetically engineered (via known techniques adapted to the teachings herein, as with any other genetically engineered biological material) to provide crack healing, expression of gas vesicles for detection by ultrasound, and/or expression of chlorinating enzymes.

Additionally, environmental conditions such as the expected temperature, humidity, presence of microbials, etc. may be considered when selecting the particular strain. For instance, strains used for concrete repair in marine conditions may be those that grow within a temperature range likely to be encountered in seawater, e.g., (0-30° C.), in on-ground concrete (e.g., 10-70° C.), etc. Similarly, a strain may be selected based on its microbial contaminant resistance.

In other approaches, spores are used in the capsules. The strain selected may be one that will germinate and form mycelium from spores encapsulated in the capsules.

In some approaches, the fungi are able to germinate and function upon contact with plant substrates that are representative of indigenous materials in the location of use.

In other approaches, the casting suspension includes a material that enables germination of the spores after contact between the spores and the material, e.g., when the capsule containing the spores ruptures, allowing the material to enter the capsule and/or the spores to exit the capsule.

Fungal spores are useful in repair formulations according to various approaches due to their potential for long-term storage, ease in application, and capability to work with indigenous raw materials (e.g., local plants, debris, soil) such as when used for runway patch repairs. Fungal spores have a long shelf life (years), and encapsulation and suspension in the gelcast slurry provides a stable compartment for the spores to persist during shipment in repair kits. In preferred aspects, a bioengineered fungal species that functions for both vascularization and MICP is present in the capsules of the repair formulation.

Genetic engineering of one or more fungal species may be performed to enhance vascularization. Basic genetic engineering tools and methodologies may be adapted for this purpose, e.g., based on known techniques for benchmark strain P. ostreatus. In one exemplary approach, before transformation begins, fungal mycelia are grown for 4-5 days and then treated with commercially available lysing enzymes to strip off the cell walls and create protoplasts. Then, either homologous recombination or the Agrobacterium/T-DNA mediated system can transform the protoplasts. Carboxin resistance may be used as a marker for genetic transformation. RNA sequencing may be performed on these strains under diverse growth conditions to identify inducible and/or constitutive strong promoters for use in various approaches.

Fungal vascularization may be enhanced by two approaches: (1) bioengineering fungi to overexpress proteins and (2) evaluating different lignocellulosic substrates to incorporate within the repair formulation. After capsule rupture, fungal spores will germinate and grow in the presence of the lignocellulosic substrates, such as those derived from wood micro-particles substrate varieties (e.g., oak, pine, poplar, etc.). Preferably, the lignocellulosic substrates are predetermined to be compatible with the casting suspension (e.g., based on the particle-to-slurry ratio), for the capability to enhance fungal growth (capability to support the target depth integration), and strengthen concrete (e.g., >26 MPa compressive strength).

An illustrative method for bioengineering fungi includes causing fungi to overexpress proteins found in bones and teeth (e.g., collagen, enamerin, and amerogenin) and secrete them from fungal strains to tune the properties of the resulting materials to mimic these natural materials. For instance, different expression levels may be tested for each protein for effect on the speed of crystal formation.

Industrial-scale production of mushrooms is well-established, with global production of 10 million tons in 2014. Thus, existing processes, such as the monotube method, may be used for spore production and harvest. With forced air circulation and spore collection filters installed, variations in light, temperature, and chemicals may be tested and optimized to maximize spore yield and minimize production cost. Continuous cultivation techniques may also be used.

### Capsule and Casting Suspension Formulations

For crack repair, one preferred approach is gelcasting of the repair formulation. An exemplary gelcastable repair formulation includes ceramic particle fillers (e.g., of a type noted elsewhere herein), capsules (and inner cargo), and an aqueous gellating polymeric solution. The gellating polymeric solution may include any known solution suitable for gelcasting, and should be compatible with the capsules and/or the concrete to be repaired for long term storage and/or repair. Gellating polymeric solutions according to various approaches may include one or more monomers, a cross linker, a free radical initiator, cement, diatomaceous earth, and/or catalysts placed into an aqueous suspension.

Gelcasting is particularly useful for filling cracks in concrete, as gelcast material creates ceramics with minimal shrinkage, cracking, and warping, and can impart a range of functionalities (e.g., microwave absorption, magnetic properties, added stiffness), depending on the fillers. This mixture of precursors conforms to a slurry that may then be foamed before it undergoes a direct consolidation step. In this step, the binder becomes polymerized to consolidate the particle structure within the precursor slurry. The process then forms a gel type of mixture, which is then cast into the crack in the concrete, e.g., via injection into the crack.

The gelcasting suspension used preferably imparts high compressive strength and vascularization with crack repair by formulating the polymeric solution with seed materials (e.g., CaCO₃ biomineralizing enzymes, lignocellulosic substrates, Ca²⁺) and encapsulating biomaterials for CaCO₃ precipitation (enzymes or microbes) and Cl⁻ binding (enzymes). Capsules provide long-term durability for inner cargo and enable self-healing capabilities prompted by capsule rupture, releasing, and activating the inner components.

Capsules may, in some approaches, be produced via bulk emulsification techniques.

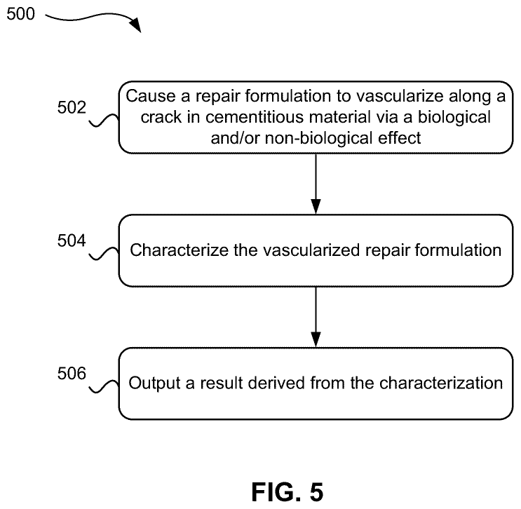

FIG. 6 depicts a method 600 for capsule formation via emulsification, in accordance with one embodiment. As an option, the present method 600 may be implemented to form capsules such as those described elsewhere herein and/or shown in the other FIGS. described herein. Of course, however, this method 600 and others presented herein may be used to [form structures for a wide variety of devices and/or purposes, provide applications] which may or may not be related to the illustrative embodiments listed herein. Further, the methods presented herein may be carried out in any desired environment. Moreover, more or less operations than those shown in FIG. 600 may be included in method 600, according to various embodiments. It should also be noted that any of the aforementioned features may be used in any of the embodiments described in accordance with the various methods.

In step 602, a suspension is formulated using a solvent (e.g., water), the inner cargo of the capsules (e.g., biological material, nutrients, etc.), and a gelling agent.

In step 604, oil and surfactant are added to the suspension to create a mixture.

In step 606, the mixture is agitated, e.g., via sonification, etc., to form an emulsion.

In step 608, the emulsion is cured at a predefined temperature for an effective amount of time to enable formation of droplets.

In step 610, the oil is removed and the cured emulsion is dried, thereby enabling collection of the capsules.

Compatibility of the capsule cargo with the encapsulation process and the capsule shell material (e.g., alginate, gelatin, polyvinyl alcohol, polyethylene glycol, etc.) may be short term or long term, depending on the intended use of the repair formulation. The capsule shell mechanical properties may be optimized to prevent premature leaching of cargo and ensure adequate capsule rupture under applied loads. The effects of fluid properties (e.g., density, viscosity) on successful encapsulation may be considered when selecting capsule shell properties.

For the capsule cargo, preferred approaches use CaCO₃ biomineralization methods (e.g., see FIGS. 3A and 3B) for concrete crack repair and strengthening. Two exemplary CaCO₃ biomineralization methods include use of an enzymatic system, and use of microbial-induced calcite precipitation (MICP).

The biomineralization option selected for a given repair formulation may be selected based on its functionality (e.g., crack filling, strength recovery) and longevity within the capsules. In further approaches, where multiple options are viable, a combination of capsule types with varied CaCO₃ forming mechanisms may be employed for versatility and prolonged functionality.

In some aspects of the present invention, the capsules may include an agent for biological and/or nonbiological chloride removal, as described in more detail below. In one exemplary approach, an enzymatic Cl⁻ binding system may be used for corrosion prevention.

### Enzymatic CaCO₃ Precipitation

In one approach, an enzymatic capsule includes Carbonic Anhydrase (CA), which is similar to the extremely efficient CO₂ transfer process in biological cells. CA catalyzes an irreversible reaction between Ca²⁺ and CO₂ in air to form CaCO₃ with similar thermomechanical properties as the concrete matrix, resulting in high binding properties. The typical enzyme repair process (comprised of approximately 0.001% CA) has estimated daily yields of at least 220 g/L CaCO₃. Moreover, some isoforms of CA function over a broad temperature range (e.g., 10-45° C., optimum 30-38° C.).

The main issue with using CA for enzymatic healing is the CA viability for prolonged use. To address this, the CA may be encapsulated in the capsules, providing durability (e.g., protection from pH extremes) and is preferably provided with a consistent Ca²⁺ source (e.g., provided by the gelcasting suspension, capsule, and/or aged concrete). The rapid crystal growth with CA heals large, mm-scale flaws within days, and is inexpensive, biologically safe, and avoids using unhealthy reagents. Thus, CA can efficiently repair and strengthen existing aged concrete.

The compatibility and durability of CA for encapsulation is high, such that greater than 90%, and ideally at least 95%, of the encapsulated materials maintain CaCO₃ biomineralizing function after capsule rupture. Because there is minimal influx of CO₂ into the capsule, the enzyme will not be active until the capsule rupture and will remain viable long term.

For selection of the enzyme and concentration thereof in the capsules and/or in the repair formulation, enzyme functionality may be evaluated via weight gain and crystal growth using known techniques. The crystal-crack interface and the nanomechanical properties of the crystal bridges before and after crack healing may also be evaluated. In one approach for cementitious marine conditions, the enzyme is preferably present in a concentration necessary to provide crack healing.

In some approaches, non-encapsulated CA is directly incorporated into the gelcasting suspension and mixed with the subgrade and capping concrete formulation, providing immediate improvements in strength, e.g., as noted in U.S. Provisional Appl. No. 63/539,303, which has been incorporated by reference.

In further approaches, the repair formulation may include both encapsulated and non-encapsulated CA.

In another approach, the capsules may include urease for crack healing. The urease converts urea to ammonia and bicarbonate. The bicarbonate complexes with calcium to form calcium carbonate.

### Microbial-Induced Calcite Precipitation (MICP)

In one approach, biological mineralization of fungal hyphae or in yeast is used to further strengthen mycelia-based materials. Urea amidolyase may be expressed in Saccharomyces boulardii (a eukaryotic system) and materials may be biomineralized based on CaCO₃ and CaPO₄ (hydroxyapatite), e.g., as noted in U.S. Provisional Appl. No. 63/539,303, which has been incorporated by reference. The compositions of these materials are similar to those of bones and teeth, some of the most robust biomaterials known.

Bioengineering may be performed to impart particularly useful properties on fungal strains usable in the repair formulation. Fungal strains may be developed to express urea amidolyase, carbonic anhydrase, or urease. Preferably CaCO₃ are formed across the vascular systems of these strains. The strains may be bioengineered for biocontainment.

### Biological Chloride Removal: Chlorinating Enzyme

To prevent rebar corrosion by free chloride, microbial chlorinating enzymes (e.g., chloroperoxidase and/or chlorinase) may be encapsulated and used in a repair formulation, in some approaches. See, e.g., FIG. 4 and related description. These enzymes may be used in native form. In other approaches, the enzymes may be bioengineered to improve their enzymatic activity for the particular intended use, e.g., in marine cementitious environments (e.g., >pH 10, 10-50° C., 20-37% salinity), because the native enzymes are known to have optimal function at lower pH (e.g., native chloroperoxidase optimum pH<5 and chlorinase activity demonstrated at pH 7-8). Enzymatic activity may be improved for highly alkaline and saline conditions and a range of temperatures by creating genetically diversified mutants of chlorinating enzymes using directed evolution according to known techniques. Directed evolution has successfully been achieved previously on chlorinating enzymes to enhance chlorinating activity at alkaline pH, and increase epoxidation activity in organic solvents. Directed evolution may be conducted using known random mutagenesis protocols for chlorinating enzymes.

Enzymes exhibiting enhanced chlorination reaction may be selected by high throughput screening and selection coupled with colorimetric assay. Briefly, in one experimental approach that may be scaled up, plasmid libraries (expected library size 2×10⁴) encoding evolved enzyme mutants may be transformed to E. coli, and 5,000-10,000 colonies may be picked and lysed in 96-well plate formats. Chlorinating properties of cell lysate containing enzyme mutants may be quantified by a colorimetric assay based on absorbance change of N,N,N′,N′-Tetramethyl-p-phenylenediamine (TMPD) or thionin upon chlorination, or competitive chelation between Hg²⁺ and Fe²⁺ in the presence of 2,4,6-Tri (2-pyridyl)-s-triazine (TPTZ) as a chelating agent using spectrophotometry.

The chlorinating enzymes used in various embodiment of the repair formulation preferably exhibit a chloride reduction amount of ≥25% in marine environments, as may be determined a priori by bench-scale cementitious marine experiments involving aqueous batch reactors and concrete microcosm. The enzymes used in various embodiments of the repair formulation are also preferably compatible with the encapsulation used and continued function (e.g., ≥75% enzymes active) after capsule rupture. The enzymes may be bioengineered to provide enhanced functional activity relative to wild-type enzymes.

Chlorinating enzymes may be produced in large-scale quantities using known techniques adapted for this purpose. One approach may be use of an automated fermentation system.

### Non-Biological Chloride Removal

Calcined layered double hydroxide (CLDH) formed in a concrete matrix binds free Cl⁻, but CLDH amounts around concrete cracks is negligible relative to an inexhaustible source of Cl⁻ ingress. Modified CLDHs with increased Cl⁻ uptake capacity may be incorporated into the gelcasting suspension to capture Cl⁻ from existing concrete defects and seawater ingress once the cracks are filled. The Cl⁻ uptake capacity of modified CLDHs from the complex marine-concrete environment may be optimized by varying CLDH compositions, nanostructure, and calcination temperature. The dosage of CLDHs in the gelcasting system is preferably optimized for the crack-filling and mechanical properties.

Any suitable type of CLDH may be used, such as magnesium-based CLDH, aluminum-based CLDH, calcium-based CLDH, iron-based CLDH, zinc-based CLDH, blends of CLDHs, etc. CLDHs are typically mineral particles after calcination.

There is risk of reduced enzymatic functionality with high pH. To mitigate this, the pH of the gelcasting suspension may be controlled by incorporating one or more known buffers compatible with the slurry, in a manner that would be understood by one skilled in the art after reading the present disclosure.

In some approaches, the repair formulation may provide up to about 26 MPa concrete compressive strength (and in some cases likely stronger), and prolonged function for several months, e.g., up to about 6 months, and likely longer. Chloride reduction capability may be provided by the repair formulation to achieve ≥25% reduction over time.

For CaCO₃ precipitation, CA may be purchased from any known vendor thereof, such as Sigma Aldrich. Fungal MICP may be obtained using the techniques described elsewhere herein. The chlorinating enzyme mutants, CA, and/or urease described above may be produced and purified at scale using a fermenter, in conjunction with centrifugation, continuous-flow homogenization, and high-throughput affinity chromatography via techniques that would become apparent to one skilled in the art after reading the present disclosure.

To evaluate the effectiveness of the repair formulation for self-healing vascularization within concrete, in accordance with some approaches, NDE may be used to provide empirical data on whether the ongoing repair is continuous for at least a predetermined amount of time, e.g., >6 months, >1 year, etc. The NDE used is preferably field-applicable NDE (e.g., portable microwave system and/or ultrasound) to interrogate integration, crack healing, and/or Cl concentrations.

Benchmarking Vascularization with X-Ray CT

Micro CT may be used in some approaches to characterize the vascularization in cracked microcosm samples for NDE calibration. A new CT protocol may be used, which combines CT scanning and digital volume correlation and allows using the same specimen to observe the healing effects. FIG. 10 of U.S. Provisional Appl. No. 63/539,303, which has been incorporated by reference, compares the CT images and strain fields (under uniaxial compression) of the same specimen before and after self-healing of stress-induced cracks, obtained using this approach. Further processing may be performed to generate visualization of the principal strain and the healing efficiency. Characterizations of the same specimen over time enable evaluations of the healing rate and also verify whether a predefined crack filling target rate (e.g., 0.0005 mL/(day*mL Concrete)) is achieved. In addition and/or alternatively, a machine-learning derived pipeline may be used to differentiate cracks from pores and quantify unfilled cracks and cracks healed with vascularization using deep learning-based image segmentation models (e.g., random forest classifier). Overall, CT may be used to quantify vascularization and calibrate other NDE tools.

In a preferred approach, the NDE system is a portable microwave-based NDE system that may be transported to the site to be tested.

In preferred aspects, the vascularized network results in a longevity of repair for >1500 passes of aircraft rolling thereover, more preferably >10000 passes. The aircraft may be of a typical size and weight for the location of the repair.

### Repair Formulation Applications

Preferably, the repair formulation can be applied at the concrete structure surface, where the repair formulation wicks into the cracks. In one approach, the repair formulation is spread onto the surface of the concrete along the crack. In another approach, the repair formulation is injected into the crack along the surface of the concrete via a nozzle, syringe, etc.

As noted above, vascularization may be induced in several ways. For example, after surface infiltration, vascularization via MR may be directed by the magnetic field direction and strength, with an infiltration rate of a few minutes. Fungal vascularization relies on fungal growth after capsule rupture. The released fungal spores germinate or released fungal mycelia, forming a mycelia network, especially in the presence of favorable lignocellulosic substrates, e.g., previously added to the repair formulation.

Both MR and fungal vascularization strategies may be used together to transport the self-healing components of the repair formulation throughout the concrete structure. Thus, the MR enables faster (minutes) infiltration and can provide a transport mechanism for the encapsulated spores. Subsequently, the fungal vascularization strategy enables prolonged function over months to years because of the delayed release capsule mechanism.

Note that in some repair scenarios, there may be limited crack connectivity within a concrete structure, preventing the distribution of the repair formulation beyond the surface. Accordingly, a strategically drilled small (e.g., mm-scale) hole may be created to provide connectivity from the surface to non-surface cracks. The precise location for drilling a hole can be determined using a microwave-based NDE probe, for example. Preferably, the hole is small enough to allow infiltration of the repair formulation without concrete damage.

### Repair Formulation Optimization

Repair formulations of various compositions may be created according to the teachings herein for repair of particular types of concrete and/or concrete in particular environments (e.g., marine, runway, highway, structural (e.g., bridge, building), etc.).

Based on the teachings herein, those skilled in the art will be able to select the proper combination of components for easy-to-adopt and deployable methods for vascularization, self-healing, and/or Cl⁻ binding within aged concrete of any particular type in any reasonable environment. The various potential components (e.g., magnetic particles, bioengineered fungi and/or bacteria, CA, chlorinating enzymes, lignocellulosic substrates, polymeric gel network, etc.) may be tuned for bulk production and self-healing vascularizing function in a desired environment by performing systematic studies via routine experimentation to ensure process and material compatibility (e.g., optimizing the magnetic particles, capsule cargo, suspension-to-capsule ratio). Moreover, the ratio of components may be selected to provide the optimal fluidity and rheological properties for deep penetration into concrete structures and displacement of fluid already present in cracks.

In some approaches, selection of components for a particular repair formulation may include the use of an X-ray CT system has a customized function of in situ loading (e.g., compression, bending, bond stretching). The equipment may allow stretching of a healed crack and observing of the continuous healing capacity of the developed self-healing repair systems, as described in FIG. 15 and related description of U.S. Provisional Appl. No. 63/539,303, which has been incorporated by reference. The testbeds described there may be used to test the properties of self-healing systems developed by those practicing embodiments of the present invention. Such properties include, but are not limited to: (1) strength development of the repair materials; (2) strength development of the healed samples; (3) interfacial bonding; and (4) potential degradation in certain service conditions (e.g., seawater) after repairs. These studies may also be assisted with CT with in situ loading function. Outcomes of these studies may be used as inputs (e.g., material properties and interfaces) for modeling, component selection, and/or component concentrations in the repair formulations.

Following studies using the “well-controlled” mock cracks noted immediately above, realistic cracks may be created on nondamaged specimens using mechanical or thermal stresses, followed by accelerated aging (e.g., carbonation). FIG. 16 of U.S. Provisional Appl. No. 63/539,303, which has been incorporated by reference, shows surface cracks in mortar used for demonstration of capsule-based self-healing in an experiment performed by the inventors. Upon creation of the realistic cracks, crack dimensions are not explicitly known. The cracks may be healed using a repair formulation as described herein, and the efficiencies tested using both CT and validated/calibrated NDEs (based on mock cracks). This establishes a basis for using the NDEs in larger-scale testbeds and in the field.

Mesocosm testbeds may follow the same strategy of the microcosm testbeds, but with reinforcement, accelerated aging protocols can be employed at a larger scale to demonstrate the efficiency of the repair formulation with higher fidelity. At the mesoscale, both X-ray CT and NDEs can be used for characterization.

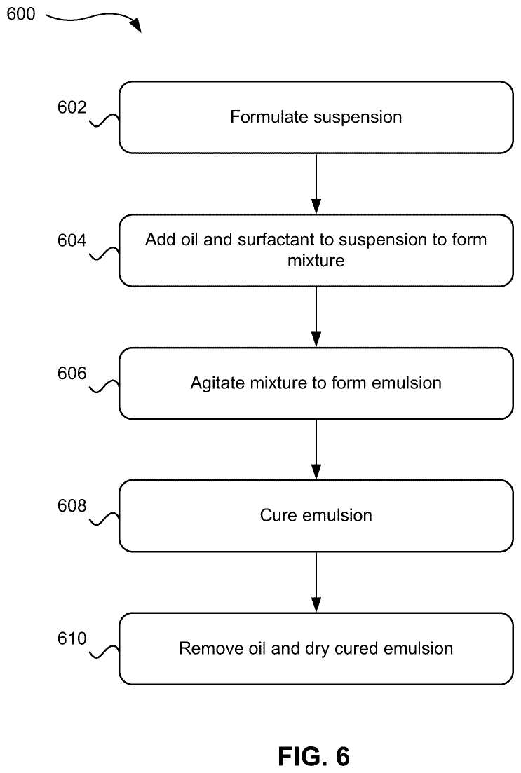

FIG. 7 is a graphical representation of a mortar beam 702 subjected to three-point bending at pressure points 706 to induce a major crack 704, upon which the major crack 704 can be readily quantified. The healing process may be documented and used to informs model for performance assessment.

Accelerated aging protocols may also provide aid to mock existing aged concrete for evaluating prolonged functionality. A sulfate attack accelerating testbed may be used for microcosm in circulating seawater to mock external cracking in field. The specimens' cracks may be evaluated using X-ray CT. After repair, the vascularizing functionality of microcosm may be evaluated using the same testbed for effectors down-selection and optimization.

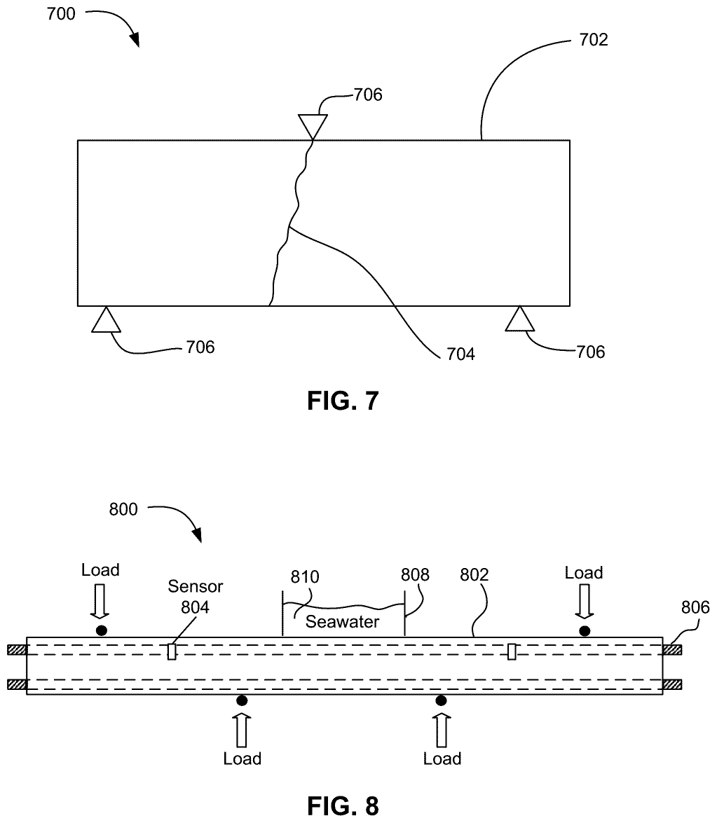

Some approaches may include an accelerated aging protocol reflecting one of the most severe deterioration scenarios for reinforced concrete subjected to bending stresses and repeated wet-dry cycles with seawater in a tidal/splash zone. This may be achieved using a loading system such as the loading system 800 depicted in FIG. 8. As shown, a beam 802 with sensors 804 therein is placed in the loading system 800. The beam 802 shown includes rebar 806. The loading system 800 bends the beam 802 upward, creating expansive stress on the top of the beam 802. A pond 808 is built on the tension zone of the beam (top surface) to store (realistic or simulated) seawater 810. The pond 808 may be formed from a barrier of any type that can store the seawater on the tension zone of the beam 802.

One can further accelerate aging by cycling bending stress and/or wetting-drying with seawater (facilitated by wind flow or temperature swing). This protocol may demonstrate the deterioration (accumulated over decades) of beams in several weeks. Similarly, columns, slabs, etc. can be deteriorated. If stress-induced or pre-made cracks are repaired with the repair formulation, and the specimens are equipped with the proposed NDEs or embedded sensors, this protocol will demonstrate the repair effectiveness of the repair formulation.

The rate and depth of transport of the repair formulation is dependent on rheology of the fluid, aperture and tortuosity of the fracture network, presence of existing fluid, and effects of poroelasticity and confining stress. Generally, the timescale of injection should be much shorter than that of the healing reactions to avoid closing off surface fractures before sufficient reactant has been delivered to the interior of a structure. Accordingly, the repair formulation usable for a given application preferably has rheological properties that enable a suitable distribution of reactants at the microscale (resolved fracture network) to allow for complete delivery of the reactants to the fracture network. In one approach, the viscosity of the gelcasting suspension may be modified, e.g., by adding a solvent, selection of materials that result in a lower viscosity, etc. In another approach, the method of injection may be selected to enhance the speed and/or penetration depth of the repair formulation. In yet another approach, the methods of enhancing vascularization noted hereinabove may be employed, e.g., magnetic and/or biological.

In some aspects, the repair formulation and/or the repair it provides is ductile to allow some tolerance for expansion and contraction (e.g., due to changes in temperature), compression (e.g., due to loading), movement from outside forces (e.g., wave action, ground shift, etc.), etc. For example, when applying the repair formulation to naval piers, it is desirable to have the ability of the vascularization to allow for continued operations under typical loading (e.g., lateral storm loading from waves, lateral compression from ship contact, vertical loading from cargo, etc.).

### In Use

The repair formulations according to the various approaches presented herein and/or the components thereof may be tunable according to the intended application space and/or the diagnostic needs of the repair. Various repair formulations presented herein may deliver an effective solution for prolonged crack repair in aged marine concrete structures and/or rapid airfield repair for national security needs.

The encapsulated microbes and/or enzymes alone may be commercialized. In another approach, the encapsulated microbes and/or enzymes with gelcasting suspension, preferably as a ready-to-use repair formulation, may be commercialized as one or a series of admixtures in the building industry for both casting new durable concrete and repairing aged concrete to extend concrete lifetime. The materials presented herein are particularly useful to concrete suppliers, concrete repair companies, govt. organization that have concrete infrastructure, etc.

In various aspects, the vascularizing effectors with biomineralization, carbon capture, and/or self-healing capabilities can be re-purposed for carbon neutral or carbon negative concrete. Energy companies may find various aspects of the disclosed invention particularly useful for activities related to the carbon management and trading market and are interested in the potential large carbon credit of concrete. The Cl⁻ enzyme described herein is particularly useful for providing corrosion resistance in reinforced concrete and alloys.

The novel portable NDE tools (e.g., ultrasound) as described herein, preferably with GUI, provide cost-effective, user-friendly solutions to monitor structural health. Such NDE tools are particularly useful in infrastructure consultancy and forensic engineering.

There have thus been described various approaches for an innovative solution for repairing aged and damaged concrete structures. The aspects described herein are particularly beneficial when used to repair decades-old marine concrete structures and airfield pavements.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A repair formulation, comprising:
a casting material; and
an encapsulated and/or non-encapsulated biological material in the casting material, the biological material being operative to enable concrete and/or mortar structural healing.

2. A repair formulation as recited in claim 1, wherein the casting material includes a casting suspension.

3. A repair formulation as recited in claim 2, wherein the casting suspension comprises a material selected from the group consisting of: a polymeric network, a polymer gel network, a lignocellulosic substrate, and a combination thereof.

4. A repair formulation as recited in claim 1, wherein the casting material includes a material selected from the group consisting of grout, mortar, and a dry powder blend.

5. A repair formulation as recited in claim 1, comprising magnetic particles in the casting material.

6. A repair formulation as recited in claim 1, wherein the casting material includes a second biological material.

7. A repair formulation as recited in claim 1, further comprising a fungus in the casting material for providing vascularization.

8. A repair formulation as recited in claim 1, further comprising ceramic particles in the casting material.

9. A repair formulation as recited in claim 1, wherein the encapsulated biological material is present in capsules mixed with the casting material.

10. A repair formulation as recited in claim 9, wherein the capsules are configured to rupture upon application of an applied stimulus thereto.

11. A repair formulation as recited in claim 9, wherein the capsules are configured to rupture upon application of an environmental stimulus thereto.

12. A repair formulation as recited in claim 9, wherein the encapsulated biological material includes a fungus for providing a function selected from the group consisting of: vascularization, self-healing, and corrosion prevention.

13. A repair formulation as recited in claim 9, wherein the encapsulated biological material includes bacteria for providing a function selected from the group consisting of: vascularization, self-healing, corrosion prevention, and enhanced NDE detection.

14. A repair formulation as recited in claim 9, wherein the encapsulated biological material includes spores and/or mycelia of a fungus for providing a function selected from the group consisting of: vascularization, self-healing, and corrosion prevention.

15. A repair formulation as recited in claim 14, wherein the casting material includes a material that enables germination of the spores after contact between the spores and the material.

16. A repair formulation as recited in claim 9, wherein the encapsulated biological material includes a biomaterial for CaCO₃ biomineralization and/or corrosion prevention.

17. A repair formulation as recited in claim 9, wherein the capsules are configured to provide vascularization crack healing and/or corrosion prevention in a crack to which applied for at least 4 months.

18. A repair formulation as recited in claim 9, wherein the capsules are configured to provide vascularization crack healing and/or corrosion prevention in a crack to which applied for at least 2 years.

19. A repair formulation as recited in claim 9, wherein the capsules are configured to provide vascularization crack healing and/or corrosion prevention in a crack to which applied for at least 5 years.

20. A repair formulation as recited in claim 9, wherein the encapsulated biological material provides at least 20 MPa of compressive strength to concrete after application thereof to a crack in the concrete.

21. A repair formulation as recited in claim 1, wherein the repair formulation is present in a package and is ready-to-use as packaged.

22. A method of performing concrete repair, comprising:
applying the repair formulation of claim 1 to a crack in concrete and/or mortar.

23. A method for non-destructive evaluation of cementitious material, the method comprising:
causing a repair formulation to vascularize along a crack in the cementitious material via a biological and/or non-biological effect;
characterizing the vascularized repair formulation; and
outputting a result derived from the characterization.
